(19) United States
(12) Patent Application Publication
(10) Pub. No.: US 2026/0135254 A1
(43) Pub. Date: May 14, 2026

(54) SOLID-STATE BATTERY

(71) Applicant: TOYOTA JIDOSHA KABUSHIKI KAISHA, Toyota-shi (JP)

(72) Inventor: Ryuto SAKAMOTO, Okazaki-shi (JP)

(73) Assignee: TOYOTA JIDOSHA KABUSHIKI KAISHA, Toyota-shi (JP)

(21) Appl. No.: 19/279,450

(22) Filed: Jul. 24, 2025

(30) Foreign Application Priority Data
Nov. 11, 2024 (JP) 2024-196990

(51) Int. Cl. H01M 50/46; H01M 4/36; H01M 10/0525

(52) U.S. Cl. CPC H01M 50/461; H01M 4/366; H01M 10/0525

(57) ABSTRACT

A solid-state battery includes a plurality of unit electrode laminates. Each of the unit electrode laminates includes at least a first current collector layer, a first active material layer, a solid electrolyte layer, a second active material layer, and a second current collector layer. The solid-state battery further includes an adhesive layer between two of the unit electrode laminates adjacent to each other. A product of an area ratio (unit: area %) of the adhesive layer on a surface of the unit electrode laminate where the adhesive layer is in contact and a thickness (unit: mm) of the unit electrode laminate is 12 or less.

### CROSS-REFERENCE TO RELATED APPLICATION

This application claims priority to Japanese Patent Application No. 2024-196990 filed on Nov. 11, 2024. The disclosure of the above-identified application, including the specification, drawings, and claims, is incorporated by reference herein in its entirety.

### BACKGROUND

### 1. Technical Field

The present disclosure relates to a solid-state battery.

### 2. Description of Related Art

For example, a battery described in Japanese Unexamined Patent Application Publication No. 2020-140932 (JP 2020-140932 A) is known as a battery in which a current collector layer and an active material layer in a unit electrode laminate are bonded by an adhesive layer.

JP 2020-140932 A discloses an all-solid-state battery including two or more stacked battery units having a monopolar structure. The stacked battery units each have a configuration in which a first current collector layer, a first active material layer, a solid electrolyte layer, a second active material layer, a second current collector layer, a second active material layer, a solid electrolyte layer, a first active material layer, and a first current collector layer are stacked in this order. The first current collector layer and the first active material layer that are stacked adjacently are bonded to each other with an adhesive.

### SUMMARY

When unit electrode laminates are bonded to each other, an uneven thickness of the active material layer etc. may cause stress between the layers, resulting in delamination.

The present disclosure has been made in view of the above circumstances, and has an object to provide a solid-state battery that is excellent in suppressing delamination inside a unit electrode laminate.

Means for solving the above problem includes the following aspects.

<1> A solid-state battery includes a plurality of unit electrode laminates. Each of the unit electrode laminates includes at least a first current collector layer, a first active material layer, a solid electrolyte layer, a second active material layer, and a second current collector layer. The solid-state battery further includes an adhesive layer between two of the unit electrode laminates adjacent to each other. A product of an area ratio of the adhesive layer on a surface of the unit electrode laminate where the adhesive layer is in contact and a thickness of the unit electrode laminate is 12 or less. The area ratio is expressed in units of area %. The thickness is expressed in units of millimeter.

<2> In the solid-state battery according to <1>, the thickness of the unit electrode laminate is 0.15 mm to 1 mm.

<3> In the solid-state battery according to <1>, the adhesive layer has electrical conductivity.

<4> In the solid-state battery according to <1>, the product of the area ratio of the adhesive layer on the surface of the unit electrode laminate where the adhesive layer is in contact and the thickness of the unit electrode laminate is 8 or more and 12 or less.

According to the present disclosure, it is possible to provide the solid-state battery that is excellent in suppressing the delamination inside the unit electrode laminate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic partial sectional view of a solid-state battery according to an embodiment of the present disclosure.

### DETAILED DESCRIPTION OF EMBODIMENTS

Hereinafter, the solid-state battery according to the present disclosure will be described in detail with reference to the drawings. Each drawing shown below is a schematic drawing, and the size and shape of each part are exaggerated as appropriate to facilitate understanding.

### Solid-State Battery

The solid-state battery according to the present disclosure includes a plurality of unit electrode laminates. Each of the unit electrode laminates includes at least a first current collector layer, a first active material layer, a solid electrolyte layer, a second active material layer, and a second current collector layer. The solid-state battery further includes an adhesive layer between two of the unit electrode laminates adjacent to each other. A product of an area ratio (unit: area %) of the adhesive layer on a surface of the unit electrode laminate where the adhesive layer is in contact and a thickness (unit: mm) of the unit electrode laminate is 12 or less.

Hereinafter, the solid-state battery according to the present disclosure will be described with reference to the drawings.

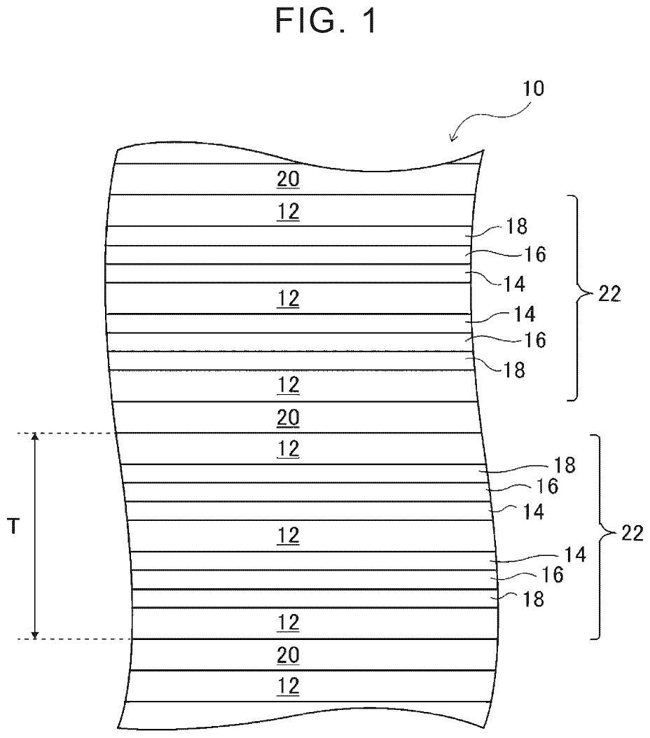

FIG. 1 is a schematic partial sectional view of a solid-state battery according to an embodiment of the present disclosure.

A solid-state battery 10 in FIG. 1 includes a plurality of unit electrode laminates 22.

The unit electrode laminate 22 in FIG. 1 includes a first current collector layer 12, a first active material layer 14, a solid electrolyte layer 16, a second active material layer 18, a second current collector layer 12, the second active material layer 18, the solid electrolyte layer 16, the first active material layer 14, and a third current collector layer 12.

The configuration of the layers of the unit electrode laminate 22 in the present disclosure is not particularly limited as long as the unit electrode laminate 22 includes at least the first current collector layer, the first active material layer, the solid electrolyte layer, the second active material layer, and the second current collector layer. The unit electrode laminate 22 may be a laminate having the configuration shown in FIG. 1, or may be a laminate including the first current collector layer 12, the first active material layer 14, the solid electrolyte layer 16, the second active material layer 18, and the second current collector layer 12.

The number of stacked unit electrode laminates 22 in the solid-state battery 10 according to the present disclosure is not particularly limited as long as it is two or more, and may be, for example, 10 to 100.

The shape and size of the solid-state battery 10 according to the present disclosure can be selected as appropriate depending on the number of stacked unit electrode laminates 22, the desired shape, etc.

The solid-state battery 10 in FIG. 1 further includes an adhesive layer 20 between two adjacent unit electrode laminates 22. By providing the adhesive layer, delamination inside the unit electrode laminate can be suppressed. In particular, delamination of the active material layer (and further an anode active material layer) can be suppressed.

The adhesive layer 20 is preferably a layer that bonds the current collector layers 12 of the two unit electrode laminates 22.

The material of the adhesive layer 20 is not particularly limited, and a known adhesive, adhesive tape, adhesive film, etc. can be used.

The material of the adhesive layer 20 may be, for example, a binder or a thermoplastic resin such as acrylic resin, polyvinylidene fluoride (PVdF), carboxymethyl cellulose (CMC), butadiene rubber (BR), or styrene butadiene rubber (SBR).

As the thermoplastic resin, for example, a polyolefin resin can be used, and specific examples thereof include low-density polyethylene (LDPE), ethylene-vinyl acetate copolymer resin (EVA), and polyimide (PI).

The adhesive layer 20 preferably has electrical conductivity.

The conductive material that imparts electrical conductivity to the adhesive layer 20 is not particularly limited, and a known conductive material such as acetylene black, carbon black, or graphite can be used.

The thickness of the adhesive layer 20 is not particularly limited, and is preferably 10 μm to 1 mm, and more preferably 20 μm to 200 μm.

In the solid-state battery 10 according to the present disclosure, the product of an area ratio (unit: area %) of the adhesive layer 20 on the surface of the unit electrode laminate 22 where the adhesive layer 20 is in contact and a thickness T (unit: mm) of the unit electrode laminate 22 is 12 or less. From the viewpoint of suppressing the delamination inside the unit electrode laminate, the product is preferably 5 or more and 12 or less, more preferably 8 or more and 12 or less, and particularly preferably 9 or more and 11 or less.

From the viewpoint of suppressing the delamination inside the unit electrode laminate, the area ratio of the adhesive layer 20 on the surface of the unit electrode laminate 22 where the adhesive layer 20 is in contact is preferably 10 area % or more and less than 100 area %, more preferably 30 area % to 85 area %, and particularly preferably 40 area % to 70 area %.

From the viewpoint of suppressing the delamination inside the unit electrode laminate, the thickness T of the unit electrode laminate 22 is preferably 0.10 mm to 2 mm, more preferably 0.15 mm to 1 mm, and particularly preferably 0.15 mm to 0.30 mm.

The solid-state battery 10 according to the present disclosure may include a laminate sheet that covers the stack of the unit electrode laminates 22 and side members (e.g., terminals) and is thermally welded to the side members.

### Members Constituting Battery

The solid-state battery 10 according to the present disclosure includes at least the first current collector layer 12 and the second current collector layer 12, and may further include a third current collector layer, a fourth current collector layer, etc.

As the current collector layer 12 including the first current collector layer 12, the second current collector layer 12, etc., for example, an aluminum foil, a copper foil, a nickel foil, a titanium foil, or a stainless steel foil can be used. The thickness of the current collector layer 12 may be, for example, 1 μm to 100 μm.

The thickness of each of the current collector layer 12, the first active material layer 14, the second active material layer 18, etc., is an average of values measured at 10 points selected as appropriate.

It is preferable that one of the first active material layer 14 and the second active material layer 18 be a cathode active material layer and the other be an anode active material layer.

The cathode active material layer contains a cathode active material that can store and release charge carriers such as lithium ions. As the cathode active material, any material available as a cathode active material for lithium ion secondary batteries may be used, such as a lithium composite metal oxide having a layered rock salt structure, a metal oxide having a spinel structure, or a polyanion compound. Two or more kinds of cathode active material may be used in combination. In the present embodiment, the cathode active material layer contains olivine lithium iron phosphate (LiFePO₄) as a composite oxide.

The anode active material layer can be made of any element, alloy, or compound that can store and release charge carriers such as lithium ions, without any particular limitations. Examples of the anode active material include Li, carbon, a metal compound, an element that can be alloyed with lithium, and a compound thereof. Examples of carbon include natural graphite, artificial graphite, hard carbon (hardly graphitizable carbon), and soft carbon (easily graphitizable carbon). Examples of artificial graphite include highly oriented graphite and mesocarbon microbeads. Examples of the element that can be alloyed with lithium include silicon and tin. In the present embodiment, the anode active material layer contains graphite as a carbon-based material.

Each of the cathode active material layer and the anode active material layer may further contain a conductive aid for increasing electrical conductivity, a binder, an electrolyte (polymer matrix, ion-conductive polymer, electrolyte solution, etc.), an electrolyte supporting salt (lithium salt) for increasing ion conductivity, etc. The components contained in the cathode active material layer and the anode active material layer, or the blending ratio of the components, and the thicknesses of the cathode active material layer and the anode active material layer are not particularly limited, and public knowledge about lithium ion secondary batteries can be referred to as appropriate. The thickness of each of the cathode active material layer and the anode active material layer is, for example, 2 μm to 150 μm. To form the cathode active material layer or the anode active material layer on the surface of the current collector layer 12, a known method such as a roll coating method may be used. To improve the thermal stability of the cathode active material layer or the anode active material layer, a heat-resistant layer may be provided on the surface (one or both sides) of the current collector layer 12 or on the surface of the cathode active material layer or the anode active material layer. The heat-resistant layer contains, for example, inorganic particles and a binder, and may also contain additives such as a thickener.

The conductive aid is added to increase the electrical conductivity of the cathode active material layer or the anode active material layer. The conductive aid is, for example, acetylene black, carbon black, or graphite.

Examples of the binder include fluorine-containing resins such as polyvinylidene fluoride, polytetrafluoroethylene, and fluorine rubber, thermoplastic resins such as polypropylene and polyethylene, imide resins such as polyimide and polyamide-imide, alkoxy silyl group-containing resins, acrylic resins such as poly(meth)acrylic acid, styrene butadiene rubber (SBR), carboxymethyl cellulose, alginates such as sodium alginate and ammonium alginate, water-soluble cellulose ester crosslinked bodies, and starch-acrylic acid graft polymers. These binders may be used alone or in combination. The solvent may be, for example, water or N-methyl-2-pyrrolidone (NMP).

A separator is a member that is disposed between the cathode active material layer and the anode active material layer to separate the cathode active material layer from the anode active material layer, thereby preventing a short circuit due to contact between the two electrodes and allowing charge carriers such as lithium ions to pass. The separator prevents a short circuit between adjacent bipolar electrodes when the bipolar electrodes are stacked.

The solid electrolyte layer 16 may be, for example, a porous sheet or a nonwoven fabric containing a polymer that absorbs and retains the electrolyte. Examples of the material of the solid electrolyte layer 16 include polypropylene, polyethylene, polyolefin, and polyester. The solid electrolyte layer 16 may have a single-layer structure or a multi-layer structure. The multi-layer structure may include, for example, an adhesive layer, a ceramic layer serving as a heat-resistant layer, etc. The solid electrolyte layer 16 may be impregnated with an electrolyte, or the solid electrolyte layer 16 itself may be composed of an electrolyte such as a polymer electrolyte or an inorganic electrolyte.

Examples of the electrolyte impregnated in the separator include a liquid electrolyte (electrolyte solution) containing a non-aqueous solvent and an electrolyte salt dissolved in the non-aqueous solvent, and a polymer gel electrolyte containing an electrolyte retained in a polymer matrix.

When the solid electrolyte layer 16 is impregnated with an electrolyte solution, the electrolyte salt may be a known lithium salt such as LiClO₄, LiAsF₆, LiPF₆, LiBF₄, LiCF₃SO₃, LiN(FSO₂)₂, or LiN(CF₃SO₂)₂. As the non-aqueous solvent, known solvents such as cyclic carbonates, cyclic esters, chain carbonates, chain esters, or ethers can be used. Two or more kinds of these known solvent materials may be used in combination.

The side member may be a current collecting side member. The current collecting side member refers to a side member including a current collecting portion at least in part. The current collecting portion is, for example, electrically connected to a tab of the battery. The current collecting side member may be the current collecting portion as a whole, or may be the current collecting portion in part. Examples of the material of the side member include metals such as stainless steel (SUS). The shape of the side member is not particularly limited, and may be, for example, a rectangular parallelepiped shape.

The laminate sheet includes at least a metal layer, and preferably further includes a weldable resin layer on the surface of the metal layer near the side member. The laminate sheet may also include a protective layer on the surface of the metal layer opposite to the side member.

Examples of the material of the weldable resin layer include an olefin resin such as polypropylene (PP) or polyethylene (PE). Examples of the material of the metal layer include aluminum, aluminum alloy, and stainless steel. Examples of the material of the protective layer include polyethylene terephthalate (PET) and nylon.

The thickness of the weldable resin layer is, for example, 40 μm or more and 100 μm or less. The thickness of the metal layer is, for example, 30 μm or more and 60 μm or less. The thickness of the protective layer is, for example, 20 μm or more and 60 μm or less. The overall thickness of the laminate sheet is, for example, 70 μm or more and 220 μm or less.

The battery includes a resin layer (e.g., a tab film) disposed on the surface of a pair of side faces of the side member. The resin layer is provided to cover part of the surface of the side member and to be interposed between the side member and the laminate sheet.

Examples of the material of the resin layer include an olefin resin such as polypropylene (PP) or polyethylene (PE). The thickness of the resin layer is, for example, 40 μm or more and 100 μm or less.

The solid-state battery according to the present disclosure is typically a lithium ion secondary battery. The battery is applied to, for example, a power supply for vehicles such as a hybrid electric vehicle (HEV), a plug-in hybrid electric vehicle (PHEV), a battery electric vehicle (BEV), a gasoline automobile, and a diesel automobile. In particular, the battery is preferably used as a power supply for driving a hybrid electric vehicle (HEV), a plug-in hybrid electric vehicle (PHEV), or a battery electric vehicle (BEV). The solid-state battery according to the present disclosure may be used as a power supply for moving bodies other than vehicles (e.g., trains, ships, and aircraft), or may be used as a power supply for electrical products such as information processing devices.

The present disclosure is not limited to the above embodiment. The above embodiment is illustrative, and anything having substantially the same configuration as, and having similar functions and effects to, the technical idea described in the claims of the present disclosure is included in the technical scope of the present disclosure.

Hereinafter, the present disclosure will be described in detail in the form of examples. The following examples are not intended to limit the applications of the present disclosure.

### Example 1

### 1. Formation of Anode Active Material Layer

Polyvinylidene fluoride (PVdF), anode active material particles (lithium titanate (LTO) particles), and a sulfide solid electrolyte (Li₂S—P₂S₅-based glass ceramic) were added to a polypropylene container and stirred with an ultrasonic dispersing device for 30 minutes. Then, both sides of an aluminum foil were coated with the mixture over a width of 64 mm.

### 2. Formation of Solid Electrolyte Layer

Heptane, butadiene rubber (BR), and a sulfide solid electrolyte (Li₂S—P₂S₅-based glass ceramic) were added to a polypropylene container and stirred with an ultrasonic dispersing device for 15 minutes. Then, the center of an aluminum foil (width of 120 mm) was coated with the mixture over a width of 70 mm.

### 3. Formation of Cathode Active Material Layer

Cathode active material particles (particles whose main phase is Li_{1.15}Co_{1/3}Ni_{1/3}Mn_{1/3}O₂) were coated with lithium niobate in an air atmosphere using a tumbling fluidized bed coating machine (manufactured by Powrex Corporation), and were fired in an air atmosphere to produce cathode active material particles with a lithium niobate coating layer.

Polyvinylidene fluoride (PVdF), the obtained cathode active material particles, a sulfide solid electrolyte (Li₂S—P₂S₅-based glass ceramic), and vapor-grown carbon fiber (VGCF, produced by Showa Denko K. K.) were added to a polypropylene container and stirred with an ultrasonic dispersing device for 20 minutes. Then, the center of an aluminum foil (width of 120 mm) was coated with the mixture.

### 4. Preparation of Three-Layer Electrode Body

The obtained anode active material layer, solid electrolyte layer, and cathode active material layer were cut to a length of 80 mm. The solid electrolyte layer was roll-pressed at 0.4 t/cm onto both sides of the laminate of the anode active material layer, the aluminum foil, and the anode active material layer such that the center positions of the coated portions were aligned, and the aluminum foil was released to transfer the solid electrolyte layer.

Then, the cathode active material layer was roll-pressed at 0.4 t/cm onto each solid electrolyte layer, and the aluminum foil was released to transfer the cathode active material layer.

### 5. Densification

The obtained laminate was densified under conditions of 165° C. and 5 t/cm to obtain a laminate having a thickness of 150 μm.

Then, a polyimide (PI) tape (thickness of 80 μm) slit to a width of 2 mm was attached to a position that was 23 mm from the end of the foil.

Further, the cathode active material layer was cut to have an area of 60 mm in width and 60 mm in length.

### 6. Attachment of Current Collector Layer

Acetylene black serving as a conductive material and an acrylic adhesive were weighed out to have a volume ratio of 20:80. Then, water was added to prepare a carbon layer composition. Next, one side of an aluminum foil was coated with the carbon layer composition at 2 μm and dried at 100° C. for 1 hour to obtain a carbon layer-containing aluminum foil.

Then, the carbon layer-containing aluminum foil was cut to a width of 57 mm and a length of 57 mm, heated at 140° C. and 5 MPa for 2 minutes, and bonded to both sides of the laminate to obtain a unit electrode laminate.

### 7. Cellularization

The unit electrode laminates and adhesive films (adhesive layers) having an adhesive area shown in Table 1 were alternately stacked, and a total of 20 unit electrode laminates were stacked. Terminals were welded, and the laminates were cellularized to obtain a solid-state battery.

### Delamination Evaluation

The produced solid-state battery was stored in a thermostatic chamber at 80° C. and then disassembled. Evaluation was conducted as to whether delamination occurred inside the unit electrode laminate. The evaluation results are shown in Table 1.

### Examples 2 and 3 and Comparative Examples 1 and 2

As shown in Table 1, solid-state batteries were produced and evaluated in the same manner as in Example 1, except that the area ratio of the adhesive layer on the surface where the adhesive layer was in contact and the thickness of the unit electrode laminate were changed.

TABLE 1

| | Thickness | Area ratio | Size of one | | |
|---|---|---|---|---|---|
| | T of unit | R of | side of | | |
| | electrode | adhesive | adhesive | Value | Delam- |
| | laminate | layer | layer | of | ination |
| | (mm) | (area %) | (mm × mm) | T × R | evaluation |
| Example 1 | 0.15 | 80 | 50 | 12 | None |
| Example 2 | 0.20 | 50 | 40 | 10 | None |
| Example 3 | 0.30 | 33 | 32 | 9.9 | None |
| Comparative | 0.15 | 100 | 50 | 15 | Present |
| Example 1 | | | | | |
| Comparative | 0.30 | 70 | 32 | 21 | Present |
| Example 2 | | | | | |

### Example 4

The process from “1. Formation of Anode Active Material Layer” to “5. Densification” was performed in the same manner as in Example 1.

### 6. Attachment of Current Collector Layer

Acetylene black serving as a conductive material and an acrylic adhesive were weighed out to have a volume ratio of 20:80. Then, water was added to prepare a carbon layer composition. Next, one side of an aluminum foil was coated with the carbon layer composition at 2 μm and dried at 100° C. for 1 hour to obtain a carbon layer-containing aluminum foil.

Then, the carbon layer-containing aluminum foil was cut to a width of 57 mm and a length of 57 mm, heated at 140° C. and 5 MPa for 2 minutes, and bonded to both sides of the laminate to obtain a unit electrode laminate.

### 7. Cellularization

One unit electrode laminate, an adhesive film (adhesive layer) with an adhesive area of 80 area %, and one unit electrode laminate were stacked, and the centers of the unit electrode laminates were heated at 140° C. and 5 MPa for 2 minutes in a 50 mm×50 mm block. Then, an adhesive film (adhesive layer) with an adhesive area of 80 area % and one unit electrode laminate were further stacked and heated. This process was repeated until a total of 20 unit electrode laminates were stacked. Terminals were welded, and the laminates were cellularized to obtain a solid-state battery.

The solid-state battery obtained in Example 4 was evaluated in the same manner as in Example 1, and no delamination was observed inside the unit electrode laminate.

As shown in Table 1 and Example 4, the solid state batteries of Examples 1 to 4 were excellent in suppressing the delamination inside the unit electrode laminate. In the solid state batteries of Comparative Examples 1 and 2, delamination of the anode active material layer occurred inside the unit electrode laminate.

What is claimed is:

1. A solid-state battery comprising a plurality of unit electrode laminates, wherein
each of the unit electrode laminates includes at least a first current collector layer, a first active material layer, a solid electrolyte layer, a second active material layer, and a second current collector layer,
the solid-state battery further includes an adhesive layer between two of the unit electrode laminates adjacent to each other, and
a product of an area ratio of the adhesive layer on a surface of the unit electrode laminate where the adhesive layer is in contact and a thickness of the unit electrode laminate is 12 or less, the area ratio being expressed in units of area %, the thickness being expressed in units of millimeter.

2. The solid-state battery according to claim 1, wherein the thickness of the unit electrode laminate is 0.15 mm to 1 mm.

3. The solid-state battery according to claim 1, wherein the adhesive layer has electrical conductivity.

4. The solid-state battery according to claim 1, wherein the product of the area ratio of the adhesive layer on the surface of the unit electrode laminate where the adhesive layer is in contact and the thickness of the unit electrode laminate is 8 or more and 12 or less.
